(19) United States
(12) Patent Application Publication
(10) Pub. No.: US 2004/0096149 A1
(43) Pub. Date: May 20, 2004

(54) Hi-isolation wavelength division multiplexer and method of producing the same

(76) Inventors: Yu-Ching Huang, Tu-Chen (TW); George Fu, Tu-Chen (TW); Abe Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/700,235

(22) Filed: Nov. 3, 2003

(30) Foreign Application Priority Data
Nov. 8, 2002 (TW) 91132845

(51) Int. Cl. G02B 6/28

(52) U.S. Cl. 385/24; 385/96

(57) ABSTRACT

The present invention discloses an HWDM (10) and a method of producing the same. The HWDM includes a WDM element (20), two receiving sleeves (30), (40), two shrink sleeves (50) and an outer tube (60). The WDM element includes a first, second, third and fourth optical fibers (21˜24). The first optical fiber is fused with the second fiber to form a first fusion region (211), and with the third fiber to form a second fusion region (212). The second fiber and the fourth fiber are fused to form a third fusion region (221). The receiving sleeves respectively contain the first fusion region and the second and third fusion regions therein. Each shrink sleeve attaches to a corresponding receiving sleeve. The outer tube receives two receiving sleeves therein.

### BACKGROUND OF THE INVENTION

1. Field of the Invention

The present invention generally relates to a wavelength division multiplexer (WDM) and more particularly to a compact, hi-isolation wavelength division multiplexer (HWDM) and a method of producing the same.

2. Description of the Related Art

At present, WDM is normally used as bulk-sized communications networks. In such networks, a plurality of light signals are multiplexed and transmitted along a single optical fiber line. Different optical wavelengths of the light signals are assigned to different receivers in the network, so multiple-to-multiple communications arrangements are made possible by WDM. Hi-isolation WDM refers to the ability of a network to isolate the individual signal wavelengths, leading to clearer signal reception.

Referring to FIG. 5, a conventional HWDM or super HWDM 70 is has a plurality of WDMs series-connected to each other, a complex light signal having wavelengths λ₁, λ₂ . . . λₙ is traveling through the serially connected WDMs to separate a specific wavelength λₙ therefrom. Wavelength isolation is effectively improved in this way. However, the two series-connected WDMs are aligned and then are fused to form a knot 71, for the reliability of the fusion knot 71, HWDM 70 is generally sealed into a protection sleeve (not shown), which can result in the package size of HWDM 70 is too large (normal is 100 mm×80 mm×15 mm), and high in cost. In addition, the fusion knots 71 can also cause a high insertion loss. Therefore, an improved HWDM that has a small package size and low insertion loss is desired.

### SUMMARY OF THE INVENTION

An objection of the present invention is to provide a HWDM that has a small package size and low insertion loss.

In order to achieve above object, the present invention discloses an HWDM and a method of producing the same. The HWDM includes a WDM element, two receiving sleeves, two shrink sleeves and an outer tube. The WDM element includes a first, second, third and fourth optical fibers. The first optical fiber is fused with the second fiber to form a first fusion region, and with the third fiber to form a second fired fusion region. The second fiber and the fourth fiber are fused to form a third fusion region. The receiving sleeves respectively contain the first fusion region and the second and third fusion regions therein. Each shrink sleeve attaches to a corresponding receiving sleeve. The outer tube receives two receiving sleeves therein.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a cross-sectional view of an HWDM according to the present invention;

FIG. 2 is a perspective, partially disassembled view of the HWDM of FIG. 1;

FIG. 3 is a fiber connection schematic view of FIG. 1;

FIG. 4 is a partially assembled view of FIG. 1; and

FIG. 5 is a schematic view of an HWDM of the prior art.

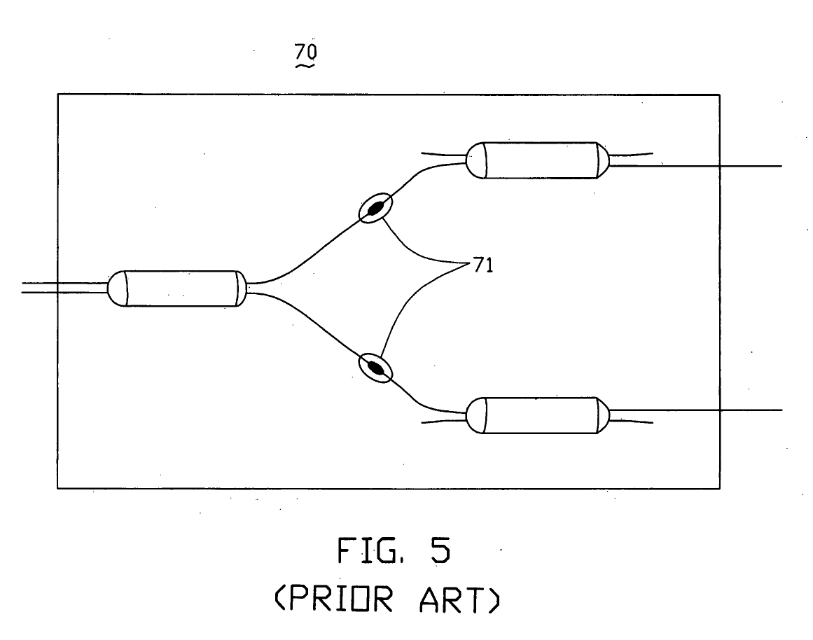

### DETAILED DESCRIPTION OF THE INVENTION

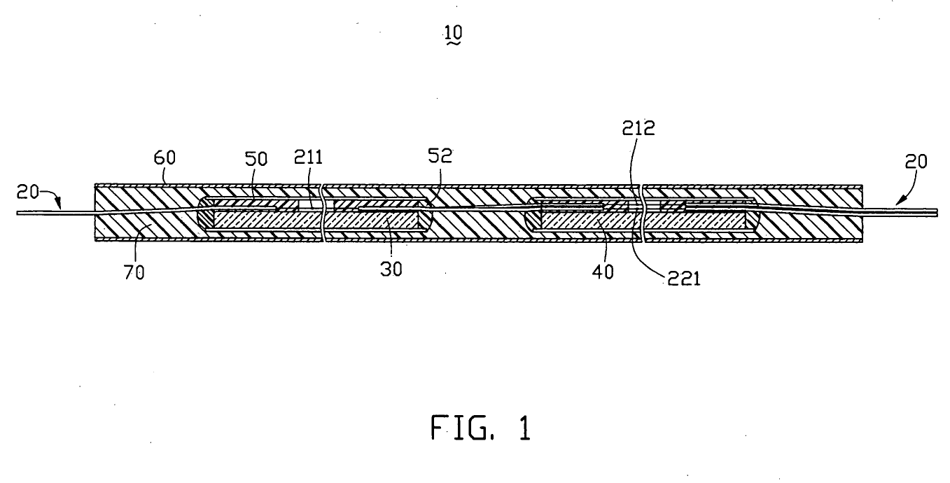

Referring to FIG. 1, a hi-isolation wavelength division multiplexer (HWDM) 10 according to the present invention includes a WDM element 20, two receiving sleeves 30, 40, two shrink sleeves 50 and an outer tube 60.

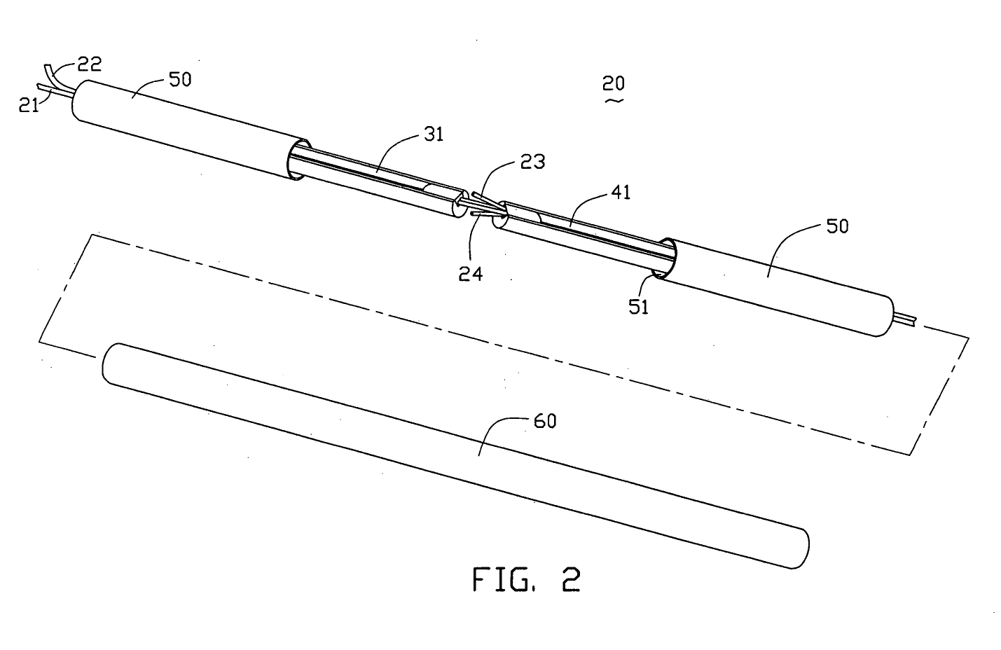

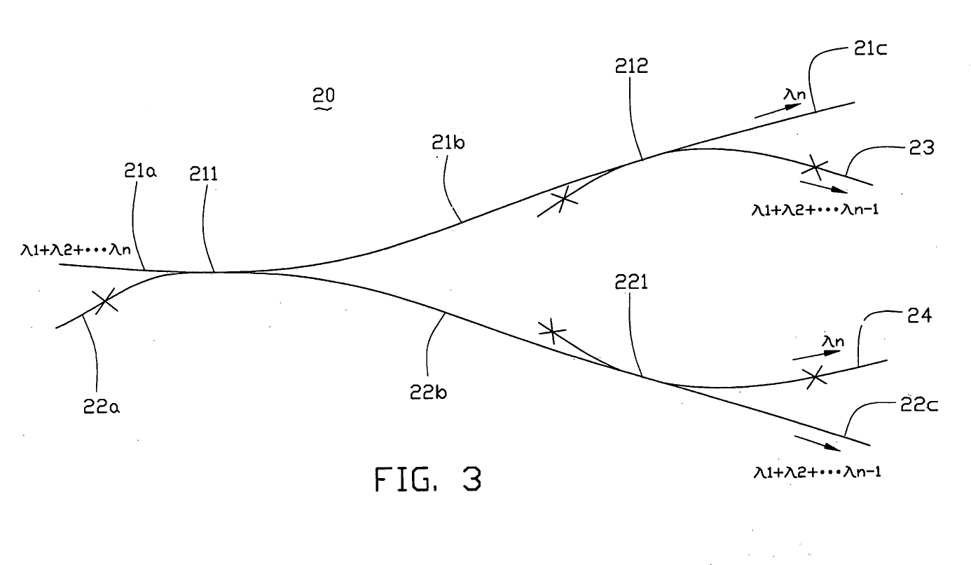

Referring also to FIGS. 2 and 3, the WDM element 20 includes a first optical fiber 21, a second optical fiber 22, a third optical fiber 23 and a fourth optical fiber 24. The first optical fiber 21 couples with a front portion 22a, 23a of the second and third optical fibers 22, 23 to respectively form a first fusion region 211 and a second fusion region 212. Portions of the first optical fiber 21 before, between, and after the fusion regions 211, 212 will be designated 21a, 21b, and 21c. The second optical fiber 22 extending from the fusion region 211 further couples with the fourth fiber 24 to form a third fusion region 221. Portions of the second optical fiber 22 before, between, and after the fusion regions 211, 221 will be designated 22a, 22b, and 22c. The first fusion region 211 is used to separate a single wavelength λₙ from a complex optical signal having wavelengths λ₁, λ₂ . . . λₙ traveling in the first optical fiber 21a. The optical signal having wavelength λₙ is transmitted to the second fusion region 212 via the first fiber 21b, the second fusion region 212 further separates this optical signal, the unwanted wavelengths near but not equal to λₙ enters into the third optical fiber 23, the wavelength λₙ is output to the first optical fiber 21c. The optical signal having wavelengths λ₁, λ₂ . . . λₙ₋₁ is transmitted from the first fusion region 211 to the third fusion region 221 via the second optical fiber 22b. The third fusion region 221 further separates this optical signal, the unwanted wavelength λₙ is transmitted to the fourth optical fiber 24, the signal having λ₁, λ₂ . . . λₙ₋₁ is output the second optical fiber 22c.

The first receiving sleeve 30 and second receiving sleeve 40 both have a same cylindrical shape. Both are made of quartz material and both respectively define a longitudinal retainer groove 31, 41 therein. The groove 31 receivers the first fusion region 211 therein, and the groove 41 receives the second and third fusion regions 212, 221 therein.

Two shrink sleeves 50 are respectively drawn over the first receiving sleeve 30 and the second receiving sleeve 40. Each shrink sleeve 50 defines a through hole 51 therein, the interior diameter of which is a little larger than the exterior diameter of the first and second receiving sleeves 30, 40.

The outer tube 60 is made of stainless steel and has a through hole (not labeled) that is larger in size than the receiving sleeves 30, 40. The receiving sleeves 30, 40, packaged in the shrink sleeves 50 are received into the outer tube 60.

A method for manufacturing the HWDM 10 comprises:

1. Positioning front portions of the first and second optical fibers 21, 22 parallel to one another, firing to fuse them and stretching to a length sufficient to cause light signal with the wavelength λₙ to be coupled to the optical fiber 21b while light with the wavelength λ₁, λ₂ . . . λₙ₋₁ is coupled to the optical fiber 22b. The first fiber 21 and second fiber 22 thus together form the first fusion region 211. The first fusion region 211 is then received into the retainer groove 31 of the first receiving sleeve 30 and epoxy resin 52 is applied to either end of the receiving sleeve 30, thereby fixing the first and second optical fibers 21, 22 into the first receiving sleeve 30.

2. Arraying the third fiber 23 and a rear portion of the first fiber 21 that extends from the receiving sleeve 30 next to each other, firing to fuse these two fibers 23, 21 and then stretching to a length sufficient to cause light signal with the wavelength λₙ to be coupled to the optical fiber 21c while light with the wavelength λ₁, λ₂ . . . λₙ₋₁ is coupled to the optical fiber 23. The portion of the first fiber 21 and the second fiber 22 thus together form the second fusion region 211. In such way, fusing the fourth fiber 24 and a rear portion of the second fiber 22 that extends from the first fusion region 211 and stretching to form the third fusion region 221. Inserting the second and third fusion regions 212, 221 into the retainer groove 41 of the second receiving sleeve 40, and sealing the retainer groove 41 as described in step 1. This step will leave the first, second, third and fourth fibers 21˜24 fixed into the second receiving sleeve 40.

Pulling the shrink sleeves 50 over the first and second receiving sleeves 30, 40. Heating the sleeves 50 to make them shrink and become closely attached to the respective receiving sleeves 30, 40. Cutting off the excess fiber lengths that extend out of the shrink sleeves 50 (Referring to FIG. 3, the fibers that labeled “×” are to be cut), sealing the ends of the shrink sleeves 50 with UV glue.

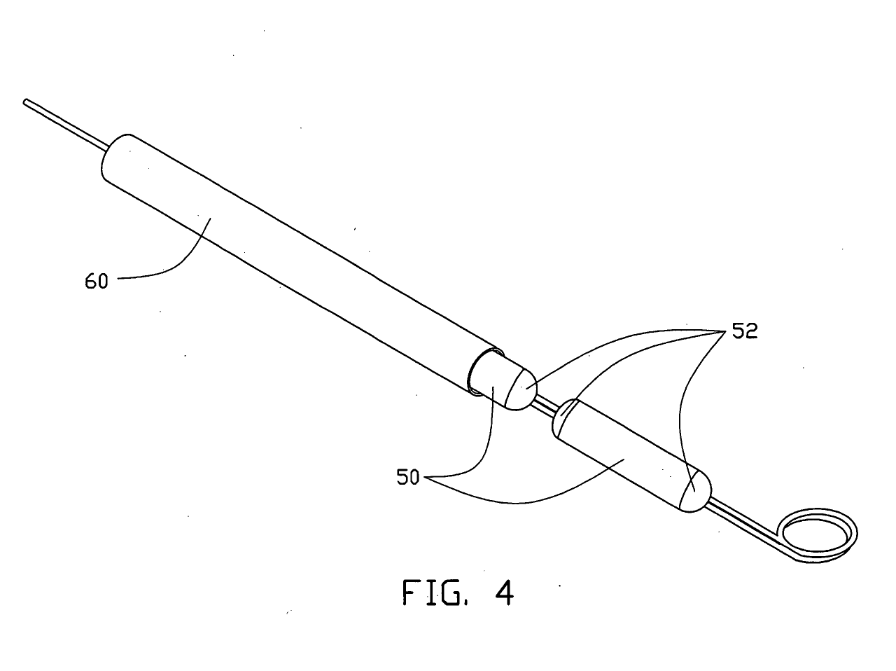

3. Inserting the receiving sleeves 30, 40 wrapped in the shrink sleeves 50 into the outer tube 60 (See FIG. 4), and applying the silicon glue in a space between the outer tube 60 and shrink sleeves 50. Drying the resulting assembly by heat, thereby fixing the receiving sleeves 30, 40 firmly into the outer tube 60.

Alternatively, the manufacturing process can be to produce the first, second and third fusion regions 211, 212 and 221 first, and then to pack the first, second and third fusion regions 211, 212, 221 into the first and second receiving sleeves 30, 40. Another embodiment of the HWDM 10 could use a plurality of optical fibers to respectively form a plurality of fusion regions therein, and the method could then follow the steps as descried above.

Compared with the referenced prior art, in the HWDM 10 the optical fiber are fused with another optical fiber, and are elongated to a length sufficient to cause light signal with the specific wavelength to be separated. The fusion knots are omitted, the insertion loss is decrease, as well as the package size of HWDM is also diminished. Therefore, the production lost will be cost down and the optical performance will be improved.

It should be understood that various changes and modifications to the presently preferred embodiment described herein will be apparent to those skilled in the art. Such changes and modifications may be made without departing from the spirit and scope of the present invention and without diminishing the present invention's advantages. Thus, it is intended that such changes and modifications be covered by the appended claims.

1. A wavelength division multiplexer assembly, comprising:
a plurality of optical fibers, a first fiber fusing with a second and third fibers and elongating to a length to form a first and second fusion regions at two different portions of the first fiber, the second fiber extended from the first fusion region further fusing with a fourth fiber and elongating to a length to form a third fusion region;
wherein a complex light signal having a plurality of wavelengths is transmitted from the first optical fiber to the first fusion region, a predetermined wavelength is separated and goes into the second fusion region, and is further separated from the second fusion region to the first fiber, the other wavelengths are transmitted to the third fusion region via the second fiber, and are further separated from the third fusion region to the second fiber.

2. The WDM assembly as described in claim 1, further including at least one receiving sleeve receiving the first, second and third fusion regions therein.

3. The WDM assembly as described in claim 2, wherein either end of said receiving sleeve is applied to glue for fixing the optical fibers therein.

4. The WDM assembly as described in claim 2, further including a shrink sleeve enclosing said receiving sleeve therein.

5. The WDM assembly as described in claim 4, wherein either end of said shrink sleeve is applied to glue for avoiding contamination.

6. The WDM assembly as described in claim 4, further including an outer tube receiving the receiving and shrink sleeves therein.

7. The WDM assembly as described in claim 6, wherein said outer tube has a through hole, the diameter of the through hole is larger than the exterior diameter of the receiving sleeve, a space between the shrink sleeve and the outer tube is sealed with glue.

8. The WDM assembly as described in claim 2, wherein the receiving sleeve is made of quartz material.

9. A wavelength division multiplexer assembly, comprising:
a plurality of optical fibers, a first fiber fusing with a second and third fibers and elongating to a length to form a first and second fusion regions at two different portions of the first fiber, the second fiber extending from the first fusion region further fusing with a fourth optical fibers and elongating to a length to form a third fusion region, in such way, the plurality of optical fibers forming a plurality of fusion regions;
wherein a complex light signal having a plurality of wavelengths is transmitted from the first optical fiber to the first fusion region, a predetermined wavelength is separated and goes into the second fusion region, and is further separated from the second fusion region to the first fiber extending from the second region, the other wavelengths is transmitted to the third fusion region via the second fiber, and a next predetermined is further separated from the third fusion region to the second fiber extending from the third region, and the plurality of fusion regions being capable of separating a plurality of wavelengths from the complex light signal.

10. The WDM assembly as described in claim 9, further including at least one receiving sleeve receiving the plurality of fusion regions therein.

11. The WDM assembly as described in claim 10, wherein either end of said receiving sleeve is applied to glue for fixing the optical fibers therein.

12. The WDM assembly as described in claim 10, further including at least one shrink sleeve enclosing the assembled receiving sleeve therein.

13. The WDM assembly as described in claim 12, wherein either end of said shrink sleeve is applied to glue.

14. The WDM assembly as described in claim 12, further including an outer tube receiving said assembled shrink sleeve therein.

15. The WDM assembly as described in claim 14, wherein said outer tube has a through hole, the diameter of the through hole is larger than the exterior diameter of the receiving sleeve, a space between the shrink sleeve and the outer tube is sealed with glue.

16. A method for producing a WDM assembly comprising:
providing at least four optical fibers;
positioning a first and second optical fibers parallel to one another, firing to fuse these two fibers and stretching to a length sufficient to cause light signal with the predetermined wavelength to be coupled to the first optical fiber while light with the other wavelength is coupled to the second optical fiber, the first fiber and second fiber thus together form the first fusion region;
arraying a third fiber and the first optical fiber that extends from the first fusion region next to each other, fusing these two fibers and stretching to a length sufficient to cause light signal with the predetermined wavelength to be coupled to the first optical fiber while light with the other wavelengths are coupled to the third optical fiber, the first fiber and the second fiber thus together form the second fusion region;
fusing a fourth fiber and the second fiber that extends from the first fusion region and stretching a length to cause light signal with a next predetermined wavelength to be coupled to the second optical fiber while light with the other wavelengths are coupled to the fourth optical fiber, thus form the third fusion region, and a plurality of fusion regions being formed in such way;
providing at least one receiving sleeve, receiving the fusion regions therein;
providing a shrink sleeve, enclosing said receiving sleeve therein, the excess fiber lengths extend out of the shrink sleeve being cut off; and
proving an outer tube and receiving shrink sleeve therein.

17. A method of claim 16, wherein either end of said receiving sleeve is applied to glue after the fusion regions is fixed thereinto.

18. A method of claim 16, wherein either end of said shrink sleeve is applied to glue after the receiving sleeve is assembled thereinto.

19. A method of claim 16, wherein a space between the shrink sleeve and the outer tube is sealed with glue after the shrink sleeve is assembled into the outer tube.
